(19) United States
(12) Patent Application Publication
(10) Pub. No.: US 2008/0203914 A1
(43) Pub. Date: Aug. 28, 2008

(54) PLASMA DISPLAY PANEL AND RELATED TECHNOLOGIES INCLUDING METHOD FOR MANUFACTURING THE SAME

(75) Inventors: Won Ki CHO, Seongnam-si (KR); Min Soo PARK, Seoul (KR); Nam Seok KANG, Seongnam-si (KR); Je Seok KIM, Anyang-si (KR); Byung Gil RYU, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/036,756

(22) Filed: Feb. 25, 2008

(30) Foreign Application Priority Data
Feb. 23, 2007 (KR) 10-2007-0018475
Feb. 23, 2007 (KR) 10-2007-0018476

(51) Int. Cl. H01J 9/14; H01J 17/49

(52) U.S. Cl. 313/582; 445/52

(57) ABSTRACT

A plasma display panel and a method for manufacturing the same, which are capable of achieving a reduction in the number of manufacturing processes and a reduction in manufacturing costs, are disclosed. The plasma display panel includes a first substrate including a first electrode, and a second substrate arranged to face the first substrate. The second substrate includes a second electrode arranged to intersect with the first electrode. At least one of the first and second electrodes include a powder mixture comprising Ag powder, and metal powder of at least one selected from a group consisting of Li, K, Ba, Ca, Na, Mg, Al, Zn, Fe, Cd, Co, Ni, Sn, Pb, Cu, Hg, Pt, and Au, and mixed with the Ag powder in a volume ratio of 0.1 to 50 mol % with respect to the Ag powder.

This application claims the benefit of Korean Patent Applications No. P 10-2007-0018475, filed on Feb. 23, 2007 and No. P 10-2007-0018476, filed on Feb. 23, 2007, which are hereby incorporated by reference as if fully set forth herein.

### BACKGROUND

1. Field

This disclosure relates to a plasma display panel and related technologies including a method for manufacturing the same. In one implementation, a plasma display panel is manufactured with reduced manufacturing processes and/or manufacturing costs.

2. Discussion of Related Art

Generally, plasma display panels include a display device in which ultraviolet rays generated in accordance with gas discharge excite phosphors to generate visible rays.

Such a plasma display panel includes discharge cells arranged in the form of a matrix. As shown in FIG. 1, an exemplary plasma display panel includes an upper substrate 1 providing an image display surface. Sustaining electrode pairs 4 are formed on the upper substrate 1. The plasma display panel also includes a lower substrate 3 defined with discharge cells by barrier ribs 2. Address electrodes 5 are formed on the lower substrate 3 such that the address electrodes 5 intersect with the sustaining electrode pairs 4.

Each sustaining electrode pair 4 includes a transparent electrode 4a and a metal (bus) electrode 4b. Over the sustaining electrode pairs 4, an upper dielectric layer 6 and a passivation film 8 are sequentially formed on the upper substrate 1.

A lower dielectric layer 7 is also formed on the lower substrate 3 such that the lower dielectric layer 7 is arranged over the address electrodes 5. The address electrodes 5 interact with the sustaining electrode pairs 4 to generate a desired plasma discharge.

### SUMMARY

Accordingly, described are a paste composition for electrodes prevents reduction of a dielectric and oxidation of electrodes, a method for preparing the paste composition, a plasma display panel using the paste composition, and a method for manufacturing the plasma display panel.

At least one implementation contemplates a paste composition for electrodes capable of providing high conductivity and high reproducibility, a method for preparing the paste composition, a plasma display panel using the paste composition, and a method for manufacturing the plasma display panel.

As implemented and broadly described herein, a plasma display panel comprises: a first substrate including a first electrode; and a second substrate arranged to face the first substrate, the second substrate including a second electrode arranged to intersect with the first electrode, wherein at least one of the first and second electrodes includes a powder mixture comprising Ag powder and a metal powder, the metal powder being selected from a group consisting of Li, K, Ba, Ca, Na, Mg, Al, Zn, Fe, Cd, Co, Ni, Sn, Pb, Cu, Hg, Pt, and Au.

In another aspect, a plasma display panel comprises: a first substrate including a first electrode; and a second substrate arranged to face the first substrate, the second substrate including a second electrode arranged to intersect with the first electrode, wherein at least one of the first and second electrodes includes metal powder comprising a metal powder core having at least one selected from a group consisting of Li, K, Ba, Ca, Na, Mg, Al, Zn, Fe, Cd, Co, Ni, Sn, Pb, Cu, Hg, Pt, and Au, and an Ag shell coated on the metal powder core.

In another aspect, a plasma display panel comprises: a first substrate including a first electrode; and a second substrate arranged to face the first substrate, the second substrate including a second electrode arranged to intersect with the first electrode, wherein at least one of the first and second electrodes includes powder comprising a metal core having at least one selected from a group consisting of Li, K, Ba, Ca, Na, Mg, Al, Zn, Fe, Cd, Co, Ni, Sn, Pb, Cu, Hg, Pt, and Au, and an anti-oxidation sacrificial film coated on the metal core.

In another aspect, a method for manufacturing a plasma display panel comprises: coating, over a substrate, an electrode paste comprising Ag powder, and metal powder of at least one selected from a group consisting of Li, K, Ba, Ca, Na, Mg, Al, Zn, Fe, Cd, Co, Ni, Sn, Pb, Cu, Hg, Pt, and Au, and mixed with the Ag powder in a volume ratio of 0.1 to 50 mol % with respect to the Ag powder; curing the coated electrode paste; and patterning the cured electrode paste into an electrode pattern.

In another aspect, a method for manufacturing a plasma display panel comprises: coating, over a substrate, an electrode paste comprising metal powder comprising a metal powder core made of at least one selected from a group consisting of Li, K, Ba, Ca, Na, Mg, Al, Zn, Fe, Cd, Co, Ni, Sn, Pb, Cu, Hg, Pt, and Au, and an Ag shell coated on the metal powder core; curing the coated electrode paste; and patterning the cured electrode paste into an electrode pattern.

In still another aspect, a method for manufacturing a plasma display panel comprises: coating, over a substrate, an electrode paste comprising powder comprising metal powder of at least one selected from a group consisting of Li, K, Ba, Ca, Na, Mg, Al, Zn, Fe, Cd, Co, Ni, Sn, Pb, Cu, Hg, Pt, and Au, and an anti-oxidation sacrificial film coated on the metal powder; curing the coated electrode paste; and patterning the cured electrode paste into an electrode pattern.

It is to be understood that both the foregoing general description and the following detailed description are exemplary and explanatory and are intended to provide further explanation.

### BRIEF DESCRIPTION OF THE DRAWINGS

The accompanying drawings illustrate aspects and, together with the description serve to explain aspects of the plasma display technology. In the drawings:

FIG. 1 is a sectional view illustrating an example of a general plasma display panel;

FIGS. 2A to 2C are schematic views illustrating the structure of conductive powder for electrodes according to a first implementation;

FIGS. 3A to 3C are schematic views of examples of the conductive powder for electrodes according to the first implementation;

FIG. 4 is a block diagram illustrating the preparation of the conductive powder for electrodes according to the first implementation;

FIG. 5 is a sectional view illustrating a plasma display panel (PDP) according to the first implemtation;

FIG. 6 is a schematic view illustrating the structure of conductive powder for electrodes according to a second implementation; and

FIG. 7 is a schematic view of an example of the conductive powder for electrodes according to the second implementation.

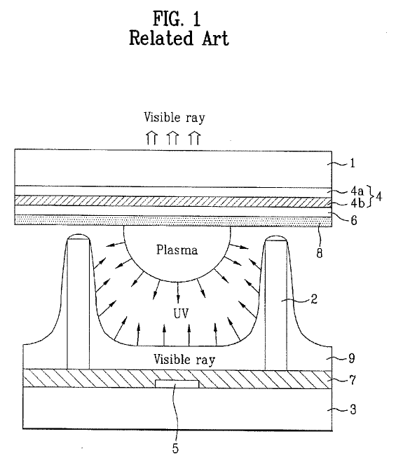

### DETAILED DESCRIPTION

Below is a description of various exemplary implementations of the technology that form a subset of the implementations contemplated. In them, when an element such as a layer, region or substrate is referred to as being “on” another element, it can be directly on the other element, or it can be separated from the other element by intervening elements or space. Also, if part of an element, such as a surface, is referred to as “inner,” it is farther from the outside of the device than other parts of the element.

In addition, relative terms, such as “beneath” and “overlies”, are used herein to describe one layer's or region's relationship to another layer or region, as illustrated in the figures. By contrast, the term “directly” is used to indicate that there are no intervening elements or layers or space.

Furthermore, although the terms first, second, etc. may be used herein to describe and distinguish various elements, components, regions, layers and/or sections, these elements, components, regions, layers and/or sections may have the orientation indicated by these terms, or they may have an alternative orientation.

A photolithography process, such as those employing a paste or a green sheet, may be used in forming high-accuracy electrodes suitable for a large-size panel.

In one implementation, a photolithography process, which uses a paste, is carried out as follows. First, a paste is printed on the overall portion of one surface of a substrate. The printed paste is subjected to a certain drying process, and is then exposed to light, using an ultraviolet light exposure device attached with a photomask.

Thereafter, the portion of the paste shielded by the photomask is removed in accordance with a developing process using a developing solution. The remaining paste, which is hardened, is then cured at a certain temperature. Thus, an electrode pattern is obtained.

The paste used in the above-described process may include conductive powder, an inorganic binder such as glass frit, a copolymer binder, a photoinitiator, and a solvent. For the conductive powder, silver, gold, copper, platinum, palladium, aluminum, or an alloy thereof may be used.

For the conductive powder, silver exhibiting excellent properties in terms of electric conductivity and anti-oxidation is mainly used. However, where silver, which is noble metal, is used in a rate of 100%, the fabrication of electrodes may form a large portion of the manufacturing costs of the panel.

Meanwhile, when metal powder such as gold, silver, copper, platinum, palladium, aluminum, or an alloy thereof is used for the conductive powder of the electrode paste, it is difficult to obtain a desired resistance required in an electrode because the metal powder is oxidized in a curing process. Even when using inexpensive metal materials, such as Al, Cu, Ni, it may be difficult to obtain a desired resistance required in a panel because, when the metal material alone is cured in the atmosphere, it is oxidized.

To this end, it is necessary to provide a process capable of achieving excellent conductivity and reproducibility while using an inexpensive alloy or mixture, or to provide such a material.

The electrode oxidation occurring in the curing process can be prevented by coating Ag on a general-purpose metal material, or coating a carbon-based compound on a general-purpose conductive material, to use the resultant product as an electrode material.

Meanwhile, the electrodes and dielectric may be simultaneously cured. Also, a nitrogen atmosphere may be used for the reduction atmosphere in the curing process. In this case, it is possible to prevent the reduction of the dielectric, and thus to reduce the number of curing processes required in the manufacture of a PDP.

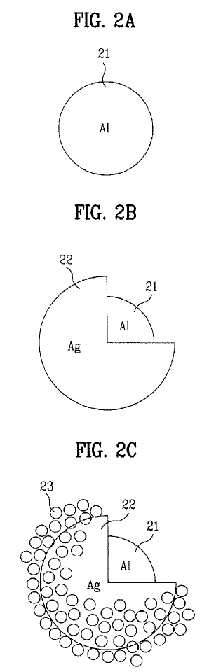

FIGS. 2A to 2C illustrate the structure of conductive powder contained in a paste composition for electrodes according to a first implementation.

The conductive powder may have a core/shell structure in which Ag is coated on general-purpose metal powder, namely, a metal core 21 as shown in FIG. 2A, to form an Ag shell 22, as shown in FIG. 2B.

Alternatively, as shown in FIG. 2C, the conductive powder may have a dual shell structure in which Ag powder 23 is coated on the core/shell structure shown in FIG. 2B.

The conductive powder having the core/shell structure may include metal powder of at least one selected from the group consisting of Li, K, Ba, Ca, Na, Mg, Al, Zn, Fe, Cd, Co, Ni, Sn, Pb, Cu, Hg, Pt, and Au, and mixed with Ag powder in a volume ratio of 0.1 to 50 mol % with respect to the Ag powder 23.

The Ag shell 22 may have a structure in which 5 to 50 wt % of Ag is coated over the circumference of the core 21.

In this embodiment, Al powder is used for the core 21. Also, as described above, Ag is coated to form the shell 22. The core 21 and shell 22 form composite powder having a particle size of 0.001 to 5 μm. The particle size of the composite powder corresponds to a particle size enabling the composite powder to be suspended in a liquid phase so that the composite powder can generate a sufficient coating (growing) reaction.

The core 21 may be formed, using an atomize process, a plasma process, or a liquid phase precipitation process. The shell 22 may he formed to have a dual shell structure, using a nucleus growing process.

The dual shell structure can be formed by coating a first shell over the core in accordance with a uniform nucleus growth of crystals having a particle size of 0.1 to 0.5 μm, and then coating a second shell over the first shell in accordance with a non-uniform nucleus growth of crystals having a particle size of 0.01 to 0.3 μm.

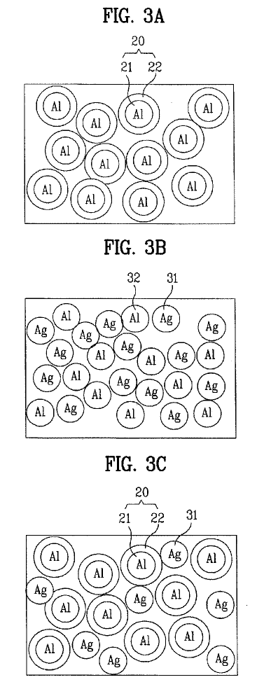

FIGS. 3A to 3C are schematic views of the particles of the electrode metal powder contained in the paste composition for electrodes according to the first implementation.

As shown in FIG. 3A, the electrode metal powder includes a plurality of metal particles 20 each including a metal core 21 and an Ag shell 22 coated over the metal core 21.

As described above, the metal core 21 is made of Al, and has a volume ratio of 0.1 to 50 mol % with respect to the Ag shell 22.

Of course, the metal core 21 may include metal powder of at least one selected from the group consisting of Li, K, Ba, Ca, Na, Mg, Al, Zn, Fe, Cd, Co, Ni, Sn, Pb, Cu, Hg, Pt, and Au.

The metal particles 20 is mixed with a vehicle, to prepare an electrode paste composition.

The electrode metal powder may be prepared by mixing Ag particles 31 with metal particles 32 made of Al, as shown in FIG. 3B.

Alternatively, the electrode metal powder may be prepared by mixing Ag particles 31 with metal particles 20 each having a structure including the metal core 21 and the Ag shell 22 coated over the metal core 21, as shown in FIG. 3C.

The metal powder may also have a dual shell structure in which Ag is dually coated over the metal particles, as shown in FIG. 2C.

The metal powder has a BET surface area of 0.1×10³ to 3×10⁶ m²/kg. Also, the metal powder may have a polygonal, spherical, or flake shape.

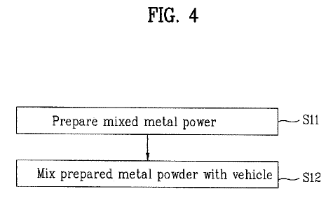

Hereinafter, the preparation of the paste for the formation of electrodes in a PDP using the above-described electrode metal powders will be described with reference to FIG. 4.

First, mixed electrode metal powder as shown in FIG. 3A, 3B, or 3C is prepared (S11). That is, the metal powder is prepared by preparing a plurality of metal particles 20 each including the metal core 21 and the Ag shell coated over the metal core 21, as shown in FIG. 3A, mixing Ag particles 31 with metal particles 32 made of, for example, Al, as shown in FIG. 3B, and/or mixing Ag particles 31 with metal particles 20 each having a structure including the metal core 21 and the Ag shell 22 coated over the metal core 21, as shown in FIG. 3C.

The prepared metal powder is then mixed with a vehicle, to prepare an electrode paste composition (S12).

The electrode paste composition can be prepared by mixing 60 to 90 wt % of the mixed metal powder with 10 to 40 wt % of the vehicle. The vehicle can be prepared, using at least one of 1 to 7 mol % of lead-free glass frit, 3 to 15 mol % of an acrylic binder, 1 to 10 mol % of a buta-acrylic solvent, 1 to 5 mol % of a dispersing agent, and a mixture thereof.

The electrode paste, which is prepared by a mixture of the metal powder and vehicle, is coated over a panel and then cured to form an electrode pattern. Thus, electrodes are formed on the PDP.

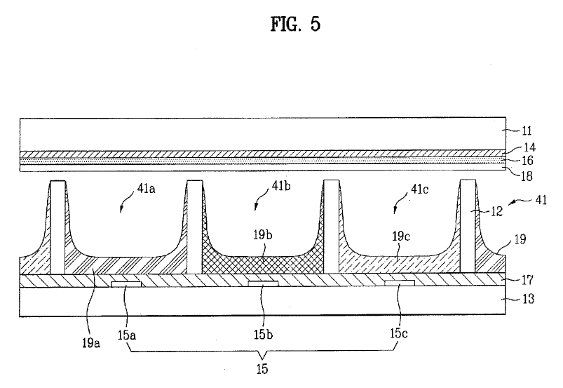

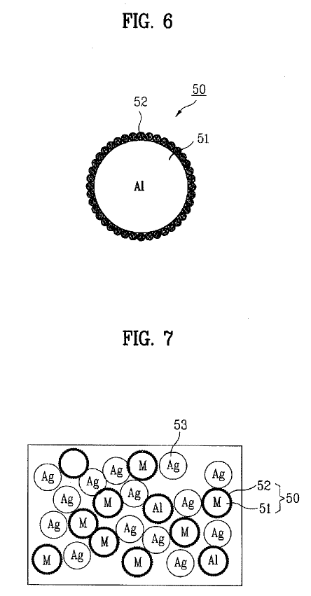

Hereinafter, the manufacture of a PDP using the electrode paste prepared as described above will be described with reference to FIG. 5.

All or a subset of the electrodes of the PDP, namely, sustaining electrodes 14, which will be formed on an upper substrate 11, and address electrodes 15a, 15b, and 15c, which will be formed on a lower substrate 13, can be formed using the electrode paste.

FIG. 5 shows one pixel of the PDP. As shown in FIG. 5, in the illustrated PDP structure, the sustaining electrodes 14 are arranged on the upper substrate 11. A dielectric layer 16 and a passivation film 18 are arranged on the sustaining electrodes 14, to cover the sustaining electrodes 14.

The address electrodes 15 are arranged on the lower substrate 13 in regions respectively corresponding to discharge cells 41 such that the address electrodes 15 intersect with the sustaining electrodes 14. A dielectric layer 17 is formed over the address electrodes 15, to cover the address electrodes 15.

Barrier ribs 12 are arranged on the dielectric layer 17, to partition the discharge cells 41, namely, discharge cells 41a, 41b, and 41c. A phosphor layer 19 is formed on each of the discharge cells 41a, 41b, and 41c.

The sustaining electrodes 14 and address electrodes 15 of the above-described PDP structure can be formed, using the paste containing the above-described electrode metal powder. Hereinafter, the formation of the electrodes will be described. First, the procedure for forming the sustaining electrodes 14 on the upper substrate 11 will be described.

In order to form the sustaining electrodes 14 on the upper substrate 11, as shown in FIG. 5, the paste prepared in accordance with the above-described procedure is coated over the upper substrate 11.

The coating of the paste can be achieved, using at least one of a photolithographic process, a screen printing process, a dispensing process, and an inkjet process.

Thereafter, the coated paste is cured. In the curing process, the vehicle present on the paste can be completely burned. The curing process can be carried out at a controlled curing temperature of 300 to 550° C.

When the curing process is carried out in a reduction atmosphere, the electrodes and dielectric layer can be simultaneously cured, using one curing process, because it is possible not only to prevent the dielectric layer from being reduced, but also to prevent the electrodes from being oxidized in the curing process. As such, with this process a dielectric layer may be deposited on an electrode prior to curing of the electrode.

Meanwhile, the procedure for forming the address electrodes 15 on the lower substrate 13 can be achieved, using the same processes as the processes used for the formation of the sustaining electrodes 14.

After the above-described procedures, the upper substrate 11 and lower substrate 13 are assembled. Thus, the PDP is completely manufactured.

The electrode metal powder according to a second implementation is powder 50 having a structure including a metal core 51 and an anti-oxidation sacrificial film 52 coated on the metal core 51. For the anti-oxidation sacrificial film 52, a carbon-based compound may be used.

The metal core 51 has a particle size of 0.1 to 1.5 μm. For the anti-oxidation sacrificial film 52, which may be made of a carbon-based compound, at least one of carbon nano tube, graphite, and amorphous carbon, or a compound prepared by a mixture of at least two of carbon nano tube, graphite, and amorphous carbon.

The anti-oxidation sacrificial film 52 may be coated on the metal core 51 in a weight ratio of 5 to 50 wt % with respect to the metal core 51 such that the volume ratio of the anti-oxidation sacrificial film 52 with respect to the metal core 51 corresponds to 0.1 to 50 mol %. In this case, the coating thickness of the anti-oxidation sacrificial film 52 may be 1 to 100 nm.

The curing temperature of the powder 50 having the above-described structure is 600° C. or more. Accordingly, the powder 50 can withstand a general electrode curing temperature (570° C.).

As shown in FIG. 7, the powder 50 may be mixed with Ag powder 53. In this case, the powder 50 may be mixed in a volume ratio of 0.5 to 90 mol % with respect to the Ag powder 53.

The core 51 of the powder 50 may be made of at least one selected from the group consisting of Li, K, Ba, Ca, Na, Mg, Al, Zn, Fe, Cd, Co, Ni, Sn, Pb, Cu, Hg, Pt, and Au.

A vehicle is mixed with the powder 50 or the mixture of the powder 50 with the Ag powder 53, to prepare an electrode paste composition.

The above-described metal powder has a BET surface area of 0.1×10³ to 3×10⁶ m²/kg. Also, the metal powder may have a polygonal, spherical, or flake shape.

The vehicle may include 1 to 7 mol % of lead-free glass frit, 3 to 15 mol % of an acrylic binder, 1 to 10 mol % of a buta-acrylic solvent, 1 to 5 mol % of a dispersing agent, or a mixture thereof.

Using the electrode paste prepared as described above, it is possible to form all or a subset of the electrodes of the PDP as shown in FIG. 5. The formation of the electrodes and the structure of the manufactured PDP may be identical to those of the above-described first embodiment.

It will be apparent to those skilled in the art that various modifications and variations to the above implementations are contemplated and readily available, and thus, are included in this disclosure.

What is claimed is:

1. A plasma display panel comprising:
a first substrate including a first electrode; and
a second substrate arranged to face the first substrate, the second substrate including a second electrode arranged to intersect with the first electrode,
wherein at least one of the first and second electrodes includes a powder mixture comprising Ag powder and a metal powder, the metal powder being selected from a group consisting of Li, K, Ba, Ca, Na, Mg, Al, Zn, Fe, Cd, Co, Ni, Sn, Pb, Cu, Hg, Pt, and Au.

2. The plasma display panel according to claim 1, wherein the powder mixture includes a mix of the metal powder and the Ag powder in a volume ratio of 0.1 to 50 mol % of metal powder to the Ag powder.

3. The plasma display panel according to claim 1, wherein the metal powder has an Ag shell coating.

4. The plasma display panel according to claim 3, wherein the Ag shell is coated in a weight ratio of 5 to 50 wt % with respect to the metal powder.

5. The plasma display panel according to claim 3, wherein the Ag shell has an Ag powder coating.

6. The plasma display panel according to claim 1, wherein the Ag shell has a dual shell structure.

7. The plasma display panel according to claim 1, wherein the Ag powder or the metal powder has a BET surface area of 0.1×10³ to 3×10⁶ m²/kg.

8. The plasma display panel according to claim 1, wherein at least one of the electrodes includes a mix of the powder mixture and Ag particles.

9. A plasma display panel comprising:
a first substrate including a first electrode; and
a second substrate arranged to face the first substrate, the second substrate including a second electrode arranged to intersect with the first electrode,
wherein at least one of the first and second electrodes includes metal powder comprising a metal powder core having at least one selected from a group consisting of Li, K, Ba, Ca, Na, Mg, Al, Zn, Fe, Cd, Co, Ni, Sn, Pb, Cu, Hg, Pt, and Au, and an Ag shell coated on the metal powder core.

10. The plasma display panel according to claim 9, wherein the metal powder core has a volume ratio of 0.1 to 50 mol % with respect to the Ag shell.

11. The plasma display panel according to claim 9, wherein the core or the cell has a particle size of 0.001 to 5 μm.

12. The plasma display panel according to claim 9, wherein at least one of the electrodes includes a mix of the metal powder and Ag particles.

13. A plasma display panel comprising:
a first substrate including a first electrode; and
a second substrate arranged to face the first substrate, the second substrate including a second electrode arranged to intersect with the first electrode,
wherein at least one of the first and second electrodes includes powder comprising a metal core having at least one selected from a group consisting of Li, K, Ba, Ca, Na, Mg, Al, Zn, Fe, Cd, Co, Ni, Sn, Pb, Cu, Hg, Pt, and Au, and an anti-oxidation sacrificial film coated on the metal core.

14. The plasma display panel according to claim 13, wherein the powder further comprises Ag powder.

15. The plasma display panel according to claim 14, wherein the anti-oxidation sacrificial film has a volume ratio of 0.1 to 50 mol % with respect to the Ag powder.

16. The plasma display panel according to claim 15, wherein the carbon-based compound comprises at least one of carbon nano tube, graphite, and amorphous carbon, or a compound including a mixture of at least two of carbon nano tube, graphite, and amorphous carbon.

17. The plasma display panel according to claim 13, wherein the anti-oxidation sacrificial film includes a carbon-based compound.

18. The plasma display panel according to claim 13, wherein the metal powder has a particle size of 0.1 to 1.5 μm.

19. The plasma display panel according to claim 13, wherein the anti-oxidation sacrificial film has a weight ratio of 5 wt % or less with respect to the metal powder.

20. The plasma display panel according to claim 13, wherein the anti-oxidation sacrificial film has a coating thickness of 1 to 100 nm.

21. The plasma display panel according to claim 13, wherein at least one of the electrodes includes a mix of the powder and Ag particles.

22. A method for manufacturing a plasma display panel, comprising:
coating, over a substrate, an electrode paste comprising Ag powder, and metal powder of at least one selected from a group consisting of Li, K, Ba, Ca, Na, Mg, Al, Zn, Fe, Cd, Co, Ni, Sn, Pb, Cu, Hg, Pt, and Au, and mixed with the Ag powder in a volume ratio of 0.1 to 50 mol % with respect to the Ag powder;
curing the coated electrode paste; and
patterning the cured electrode paste into an electrode pattern.

23. The method according to claim 22, wherein the step of coating the electrode paste is carried out, using at least one of a screen printing process, a dispensing process, and an inkjet process.

24. The method according to claim 22, wherein the curing step is carried out at a temperature of 300 to 550° C.

25. The method according to claim 22, further including coating the electrode paste with dielectric before curing the coated electrode paste, and wherein the curing includes curing the coated electrode paste and the dielectric concurrently.

26. A method for manufacturing a plasma display panel, comprising:
coating, over a substrate, an electrode paste comprising metal powder comprising a metal powder core made of at least one selected from a group consisting of Li, K, Ba, Ca, Na, Mg, Al, Zn, Fe, Cd, Co, Ni, Sn, Pb, Cu, Hg, Pt, and Au, and an Ag shell coated on the metal powder core;
curing the coated electrode paste; and
patterning the cured electrode paste into an electrode pattern.

27. The method according to claim 26, further including coating the electrode paste with dielectric before curing the coated electrode paste, and wherein the curing includes curing the coated electrode paste and the dielectric concurrently.

28. A method for manufacturing a plasma display panel, comprising:
coating, over a substrate, an electrode paste comprising powder comprising metal powder of at least one selected from a group consisting of Li, K, Ba, Ca, Na, Mg, Al, Zn, Fe, Cd, Co, Ni, Sn, Pb, Cu, Hg, Pt, and Au, and an anti-oxidation sacrificial film coated on the metal powder;
curing the coated electrode paste; and
patterning the cured electrode paste into an electrode pattern.

29. The method according to claim 28, wherein the powder has a curing temperature of 600° C. or more.

30. The method according to claim 28, wherein the anti-oxidation sacrificial film is made of a carbon-based compound.

31. The method according to claim 28, further including coating the electrode paste with dielectric before curing the coated electrode paste, and wherein the curing includes curing the coated electrode paste and the dielectric concurrently.
